(19) United States
(12) Patent Application Publication
(10) Pub. No.: US 2012/0224477 A1
(43) Pub. Date: Sep. 6, 2012

(54) PRUNED FORWARDING SET FOR SCALABLE TUNNELING APPLICATIONS IN DISTRIBUTED USER PLANE

(76) Inventors: Chandramouli Balasubramanian, Mountain View, CA (US); V.S. Jagannadham (Jack) Jonnalagadda, Menlo Park, CA (US); Brian Kean, Cincinnati, OH (US); Xianghai Yu, San Jose, CA (US); Zoltán Tóth, Budapest (HU)

(21) Appl. No.: 13/039,220

(22) Filed: Mar. 2, 2011

(51) Int. Cl. H04L 12/56

(52) U.S. Cl. 370/230

(57) ABSTRACT

A method and system for reducing congestion and latency in a communication system by creating a pruned forwarding set for scalable tunneling applications. The communication system provides a communication link between a mobile communication device and a network, such as the Internet. The method entails using information included within a data packet to determine a corresponding tunnel peer address, which is then resolved onto a set of paths. Each path includes respective adjacency information. A determination of whether to prune each respective path is made by using the respective adjacency information. The pruned set of paths is used to identify available paths for the communication link. By pruning in this manner, the line card being used as the home slot for a given session may also be used as the egress slot, thereby reducing congestion and latency in the communication system.

### TECHNICAL FIELD

The present invention relates to wireless communication systems, and more particularly, to a method and system for providing a pruned forwarding set for tunneling applications within wireless communication systems.

### BACKGROUND

The Long Term Evolution (LTE) network is an example of a highly scalable tunneling application. The gateways in the LTE network provide 3GPP access by tunneling the wireless subscriber sessions over the General Packet Radio Service (GPRS) tunneling protocol (GTP). During call setup, the tunnel parameters for the data packets are configured as part of signaling. For uplink data packets, the serving gateway (SGW) terminates the GTP-U tunnel from the radio access network and encapsulates the packets in another GTP-U tunnel destined toward the Packet Data Network (PDN) gateway (PGW). The PGW terminates the interface towards the Internet and encapsulates downlink data packet towards the serving gateway.

Scalable tunneling applications typically mandate millions of sessions to be terminated by a single node. In order to achieve system session scalability and execute stateful processing, each session's information is stored on a single user plane (UP) line card, which is termed the session's “home slot.” The homing of a subscriber session must not result in throughput degradation or delays as the packets visit the home slot for stateful processing. Further updates of tunnel peer reachability must be efficiently processed to avoid delayed or dropped packets in the forwarding path, during handoffs, tunnel changes, and/or routing changes.

Conventional Forwarding Information Base (FIB)-based packet forwarding systems do not yield optimal paths for the scalable home slot-based tunneling applications. Throughput constraints and latency issues become problematic when the scale of tunnels or sessions in such a system are increased.

### SUMMARY

In one aspect, particular embodiments of the disclosed solution provide a method for reducing congestion and latency in a communication system. The communication system is configured to provide a communication link between a communication device, such as, for example, a mobile subscriber unit, and a network, such as, for example the Internet. First, a packet is received. The packet includes identification information relating to a communication session in which the communication device is participating. The identification information is used to determine a corresponding tunnel peer address. The determined tunnel peer address is then resolved onto a set of paths. Each path includes respective adjacency information. A determination of whether to prune each respective path from the set of paths is then made by using the respective adjacency information. Based on the pruning determinations, a number of potential paths is reduced by pruning the set of paths. Finally, the pruned set of paths is used to identify available paths for the communication link.

In some embodiments, the step of resolving the determined tunnel peer address may further include creating a set of next hops corresponding to each respective path in the set of paths. The step of using the respective adjacency information may further include determining an association with each potential physical port corresponding to the respective path and calculating an adjacency value based on the determined association. The determination of whether to prune the respective path may be based on whether the adjacency information indicates that a next hop is on the same line card or on a different line card.

In some embodiments, the method further includes storing the unpruned set of paths in a database; generating and updating a set of card-specific pruned sets of paths from the unpruned set of paths; and storing each respective card-specific pruned set of paths on the respective line card. The communication device may use tunnels to participate in communication sessions.

In another aspect, particular embodiments of the disclosed solution provide a gateway node for reducing congestion and latency in a communication system. The system includes a communication device, such as, for example, a mobile subscriber unit, and a network, such as, for example, the Internet. The communication device is in communication with the network via the gateway node. The gateway node comprises a backplane; a controller card installed in a slot and coupled to the backplane, and a plurality of data cards. The controller card includes a processor. Each of the plurality of data cards is installed in a respective slot and coupled to the backplane such that at least one packet can be transmitted within the node from a first card to a second card via the backplane. Each of the data cards includes at least one port for transmitting and receiving at least one packet and a database for storing path information. By using predetermined position information relating to a current location of the communication device and identification information relating to an active communication session in which the communication device is participating, the processor uses the position information to determine a corresponding base station. The processor also uses the identification information to determine a corresponding tunnel peer address. The processor then resolves the determined tunnel peer address onto a set of paths. Each path includes respective adjacency information. The processor then determines whether to prune each respective path from the set of paths by using the respective adjacency information. Based on the pruning determinations, the processor reduces a number of potential paths by pruning the set of paths. Then, the processor uses the pruned set of paths to identify available paths for a communication link between the communication device and the network.

In some embodiments, the processor may be further configured to resolve the determined tunnel peer address by creating a set of next hops corresponding to each respective path. The processor may be further configured to use the respective adjacency information to determine an association with each potential physical port corresponding to the respective path and to calculate an adjacency value based on the determined association. The determination whether to prune the respective path may be based on whether the adjacency information indicates that a next hop is on the same data card or on a different data card.

In some embodiments, the processor may be further configured to store the unpruned set of paths in a database; generate and update a set of card-specific pruned sets of paths from the unpruned set of paths; and store each respective card-specific pruned set of paths in the database corresponding to the respective data card. The communication device may use tunnels to participate in communication sessions.

In yet another aspect, particular embodiments of the disclosed solution provide a computer program product for reducing congestion and latency in a communication system. The communication system is configured to provide a communication link between a communication device, such as, for example, a mobile subscriber unit, and a network, such as, for example, the Internet. The computer program product comprises a non-transitory computer readable medium storing computer readable program code. The computer readable program code includes instructions for causing a computer to perform several steps. The first step is to use identification information relating to a communication session in which the communication device is participating and contained in the received packet to determine a corresponding tunnel peer address. The second step is to resolve the determined tunnel peer address onto a set of paths, each path including respective adjacency information. The third step is to determine whether to prune each respective path from the set of paths by using the respective adjacency information. The fourth step is to reduce, based on the pruning determinations, a number of potential paths by pruning the set of paths. The fifth step is to use the pruned set of paths to identify available paths for the communication link.

In some embodiments, the instructions for causing a computer to resolve the determined tunnel peer address may further include instructions for causing a computer to create a set of next hops corresponding to each respective path. The instructions for causing a computer to use the respective adjacency information may further include instructions for causing a computer to determine an association with each potential physical port corresponding to the respective path and to calculate an adjacency value based on the determined association. The determination whether to prune the respective path may be based on whether the adjacency information indicates that a next hop is on the same line card or on a different line card.

In some embodiments, the computer readable program code may further includes instructions for causing a computer to perform several additional steps. These steps may include storing the unpruned set of paths in a database; generating and updating a set of card-specific pruned sets of paths from the unpruned set of paths; and storing each respective card-specific pruned set of paths on the respective line card. The communication device may use tunnels to participate in communication sessions.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 illustrates a network architecture, in accordance with exemplary embodiments of the disclosed solution.

FIG. 2A illustrates a block diagram of a gateway node used by the architecture of FIG. 1, in accordance with exemplary embodiments of the disclosed solution.

FIG. 2B illustrates an information flow diagram of a gateway node as used in the architecture of FIG. 1.

FIG. 3 illustrates an exemplary tunnel peer resolved route and next hop path chain in accordance with exemplary embodiments of the disclosed solution.

FIG. 4 illustrates an exemplary pruned path chain for a line card in accordance with exemplary embodiments of the disclosed solution.

FIG. 5 is an exemplary resolved next hop chain in accordance with exemplary embodiments of the disclosed solution.

FIG. 6 is an exemplary indexed array based on a level ordered traversal of the next hop path chain of FIG. 5

FIG. 7 is a flow chart illustrating the steps in a method according to exemplary embodiments of the disclosed solution.

### DETAILED DESCRIPTION

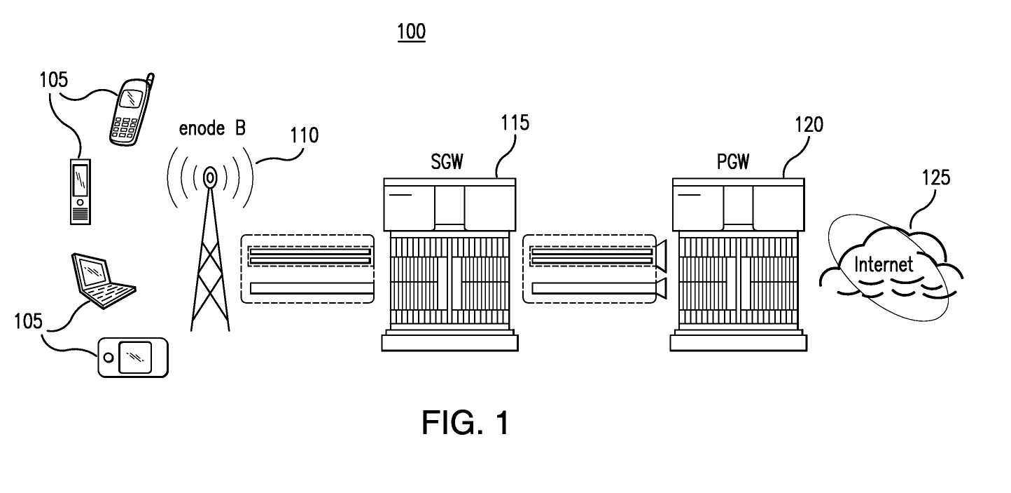

Referring now to FIG. 1, an LTE network architecture 100 for 3GPP access is illustrated as an example of a highly scalable tunneling-based application. The network architecture 100 includes a mobile communication device 105, which wirelessly communicates with a base station node 110. The base station node is communicatively coupled with a serving gateway (SGW) 115. The SGW 115 is communicatively coupled with a Packet Data Network (PDN) gateway (PGW) 120. The PGW 120 provides access to a network 125, such as, for example, the Internet.

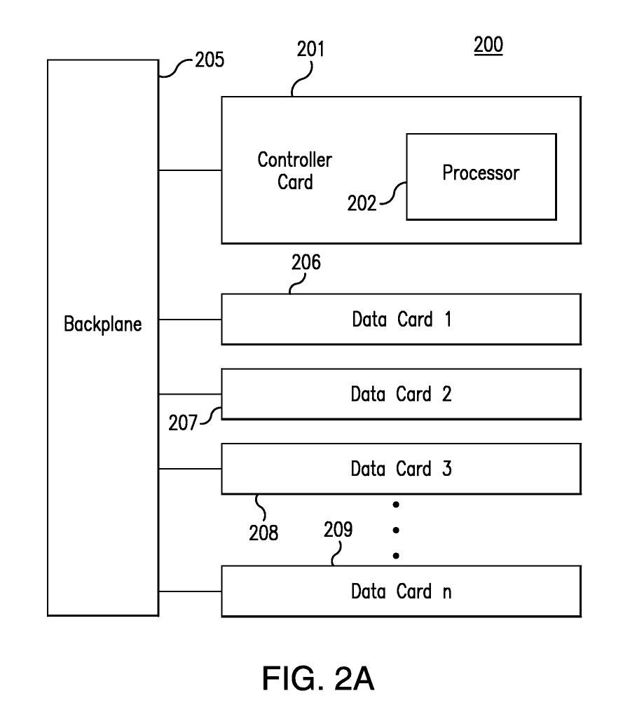

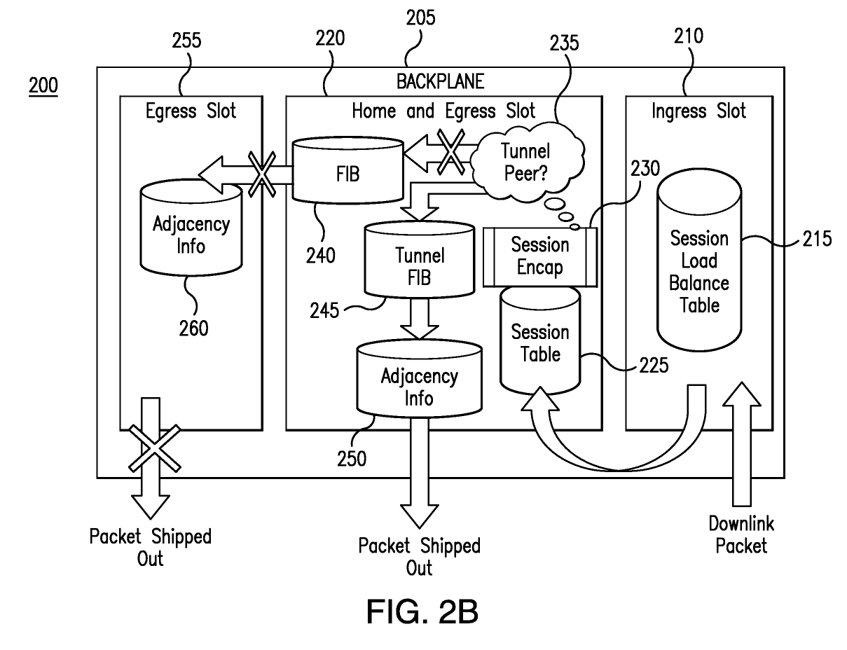

Referring also to FIG. 2A, a block diagram of a gateway node 200 is illustrated. Each of the SGW 115 and the PGW 120 includes a distributed user plane, or backplane 205. The backplane 205 provides a plurality of slots for line cards, including a controller card 201 and several data cards 206, 207, 208, 209. A processor 202 resides on the controller card 201.

The distributed user plane 205 provides the node 200 with several characteristics, including system session scalability, throughput and packet latency, and tunnel peer forwarding path update scalability. With respect to system session scalability, wireless subscriber scalability requirements mandate that millions of sessions must be terminated by a single node. In order to achieve system session scalability and execute stateful processing, each session's information is stored on a single user plane (UP) line card, which is termed the session's “home slot.”

With respect to throughput and packet latency, in the absence of a central dispatch module, upon receiving a packet, each UP line card extracts load distribution information from the packet and directs the packet to the home UP line card for session-specific processing. The home UP line card hosts all state information for a particular session. The homing of a subscriber session must not result in throughput degradation or delays as the packets visit the home slot for stateful processing.

With respect to tunnel peer forwarding path update scalability, the number of Internet Protocol (IP) addressable nodes, referred to herein as “tunnel peers,” configured in such a system is on the order of thousands. Accordingly, the number of tunnels or session that can be established between the peers could be on the order of millions.

Referring now to FIG. 2B, a conventional downlink packet's path is illustrated. Upstream network configurations cause packets to arrive on any ingress slot 210, which includes a database that stores a session load balance table 215. The ingress slot 210 is determined based on information from the packet, which also determines the home for the session to which the packet belongs, and forwards the packet to the home slot 220, which includes a database that stores a session table 225. The home slot 220 may or may not be the same as the ingress slot 210. After session processing and tunnel encapsulations at module 230, the home slot must forward the packet to a tunnel peer 235. If a conventional Forwarding Information Base (FIB) table 240 is consulted, the packet may be forwarded to a third slot 255 for egress processing, thereby introducing additional delays and throughput burden on the system. The egress slot 255 includes a database storing adjacency information 260.

In a particular embodiment of the disclosed solution, a pruned tunnel peer specific FIB 245 and a database storing adjacency information 250 is installed in each line card. A lookup on the tunnel specific FIB 245 enables choosing an egress path directly from home slot 220 by using tunnel specific FIB 245 and adjacency information database 250, instead of the conventional path through egress slot 255 using FIB 240 and adjacency information database 260.

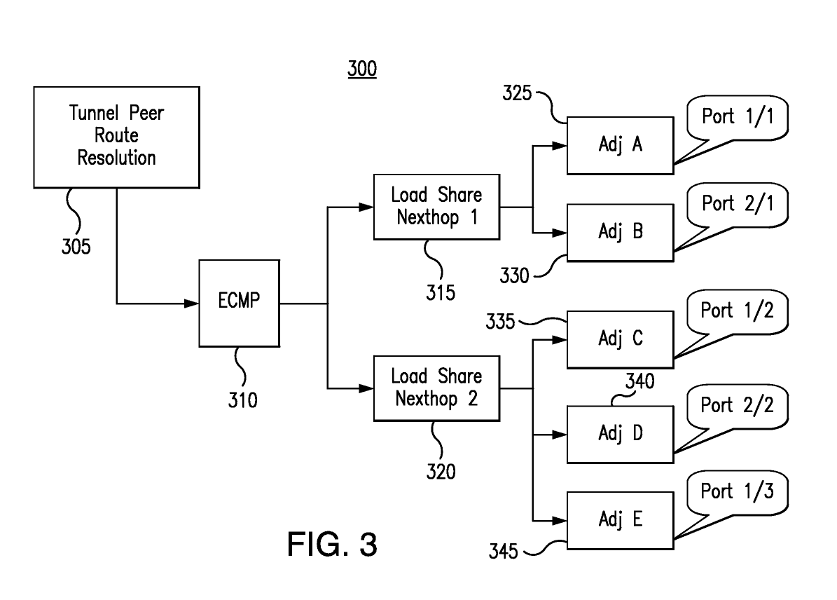

Referring now to FIG. 3, an exemplary tunnel peer resolved route and next hop path chain 300 is shown. The tunnel peer route resolution begins at block 305, and occurs over an Equal Cost Multipath 310 of load share next hops, including load share next hop 1 315 and load share next hop 2 320. Load share next hop 1 315 distributes traffic over adjacency A 325 and adjacency B 330, and load share next hop 2 320 distributes traffic over adjacency C 335, adjacency D 340, and adjacency E 345. Each adjacency is associated with a physical port. Adjacency A 325 is associated with port 1/1; adjacency B 330 is associated with port 2/1; adjacency C 335 is associated with port 1/2; adjacency D is associated with port 2/2; and adjacency E is associated with port 1/3. In this example, card 1 has 3 ports and card 2 has 2 ports, and port x/y refers to port y within card x.

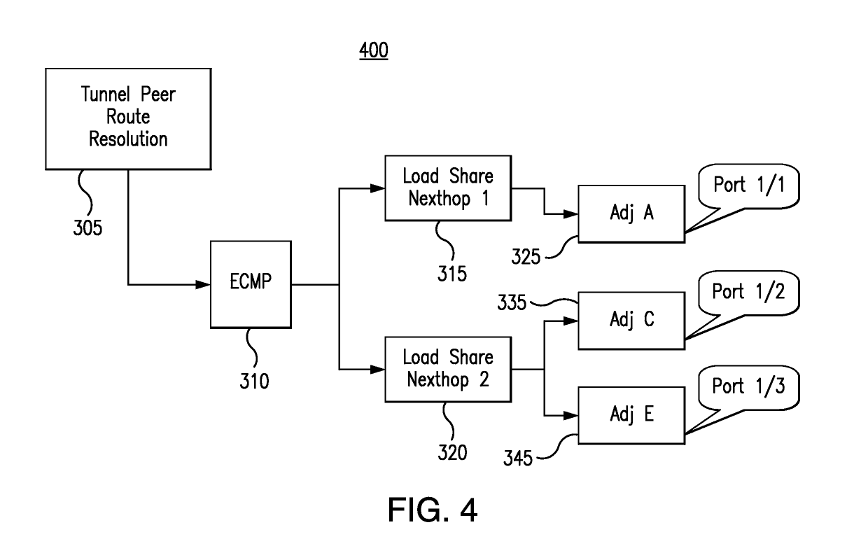

Referring now to FIG. 4, the tunnel peer resolved route and next hop path chain 300 of FIG. 3 has been pruned to form an exemplary pruned path chain 400 for line card 1, in accordance with a particular embodiment of the disclosed solution. The determination of which paths to prune is made based on avoidance of paths that lead to off-card adjacencies. In this manner, the path chain 400 is limited to adjacencies that exist on the particular card. Accordingly, because adjacency A 325 is associated with port 1/1, which refers to port 1 on line card 1, this path is not pruned. Because adjacency B 330 is associated with port 2/1, which refers to port 1 on line card 2, this path is pruned, because it leads to a different line card. Similarly, adjacencies C 335 and E 345 are not pruned, and adjacency D 340 is pruned.

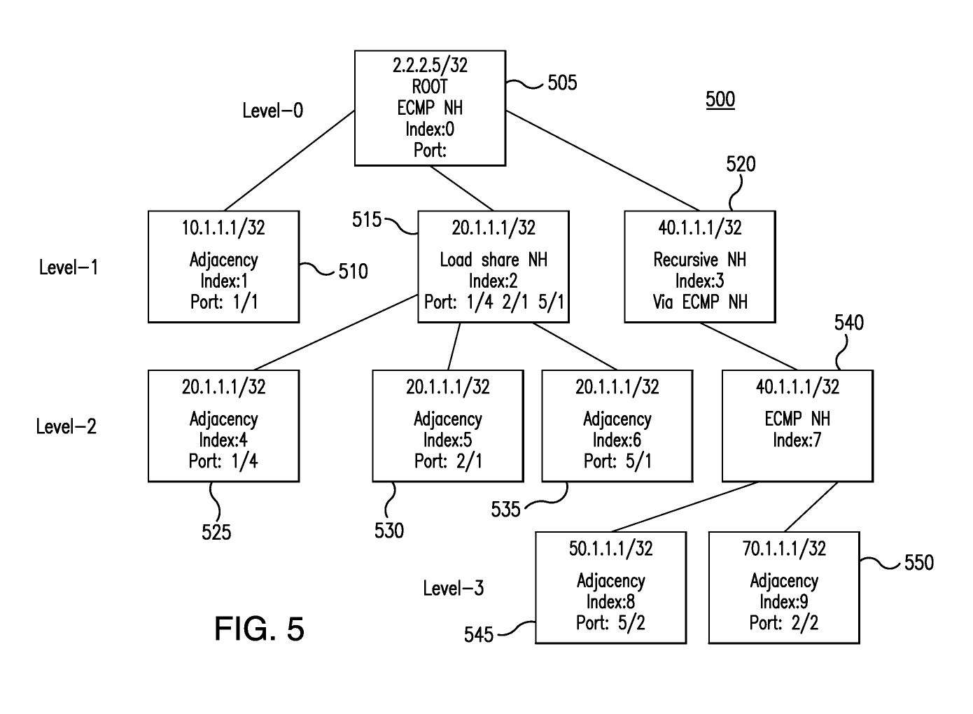

Referring now to FIG. 5, an exemplary resolved next hop chain 500 in accordance with exemplary embodiments of the disclosed solution is illustrated. The chain 500 can be derived from an algorithm to create and maintain tunnel-specific forwarding information in accordance with a particular embodiment. The algorithm includes the following steps: 1) identifying the set of destinations that constitute the tunnel peers; 2) for each destination, determining the forwarding set and partitioning the respective forwarding set based on reachability information for each slot; and 3) rebuilding the pruned forwarding set when reachability to identified destinations changes.

In node 505, route 2.2.2.5/32 is used as an example of an ECMP route. The identified route is equivalent to a tunnel end point, or destination. The exemplary route 2.2.2.5/32 is shown as being reachable via three potential next hops: Node 510, which illustrates next hop 10.1.1.1 over port 1/1, which is an adjacency; node 515, which illustrates next hop 20.1.1.1 over ports 1/4 (node 525), 2/1 (node 530), and 5/1 (node 535), reflecting a load share; and node 520, which illustrates next hop 40.1.1.1, which reflects a recursive next-hop over an ECMP (node 540) of adjacencies, including next hop 50.1.1.1 over port 5/2 (node 545) and next hop 70.1.1.1 over port 2/2 (node 550).

In the first step of the algorithm, each tunnel peer address is resolved onto a route-path, and the complete next hop result chain is created. The next hop result chain shall be rooted with the next hop identification of the route path onto which the tunnel peer address is resolved. All of the via-next hop identifications are included in the result next hop chain. To prevent duplication of data and facilitate detection of future changes in the next hop chain, only the next hop identifications of root next hop and via-next hops and the corresponding versions of these next hop identifications are saved in the result.

In the second step of the algorithm, upon re-resolution of a tunnel peer address, the results and the versions of the old and new next hop chains are compared. If no change is detected, then the routing change has no effect on this set and does not require the chain to be updated.

In the third step of the algorithm, all tunnel peer entries and the corresponding next hop chains are re-resolved, even when one route changes. Such re-resolution can be very expensive. Multiple tunnel peer entries can resolve onto the same route-path and, as a result, onto the same root next hop identification. In such a case, it is sufficient for the root next hop chain to be resolved and processed just once. Further, the root next hop chain needs to be re-resolved only once for every route change window. Each time that a root next hop is resolved, the version of the route-path onto which the entry resolved is marked in the root next hop. When other entries subsequently resolve onto the same root next hop, a determination is made as to whether the version of the route-path marked on the root next hop is within the window of the current route change processing. If so, no further resolution of the root next hop chain is necessary.

In the fourth step of the algorithm, a level-order traversal of the resolved next hop chain from the root next hop chain is performed, and an indexed array of the next hop tree is constructed.

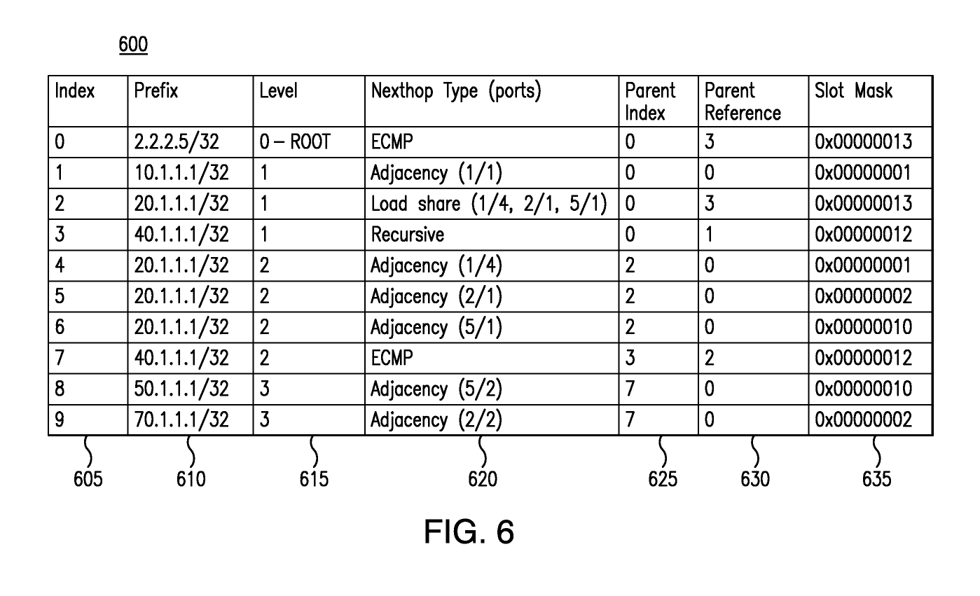

Referring now to FIG. 6, an exemplary indexed array is illustrated. In the leftmost column 605, each respective node in the resolved next hop chain 500 is assigned an index, beginning with index 0, corresponding to node 505, then index 1, corresponding to node 510, and proceeding on a one-up incremental basis to index 9, which corresponds to node 550.

In the second column 610, the next hop prefix shown in the respective block is provided. Thus, in the first row, the root prefix 2.2.2.5/32 is shown, corresponding to node 505. In the next row, the prefix 10.1.1.1/32 refers to the next hop shown in node 510. The prefixes from each corresponding node are filled into the second column 610.

In the third column 615, the level of each respective node is provided. For a given node, the level is equal to the number of next hops that occur from the root node to reach the given node. Level 0, which refers to the root node, refers only to node 505. Level 1, which includes all nodes that are exactly one next hop away from the root node, includes nodes 510, 515, and 520. Level 2, which includes all nodes that are exactly two next hops from the root node, includes nodes 525, 530, 535, and 540. Level 3, which includes all nodes that are exactly three next hops from the root node, includes nodes 545 and 550.

In the fourth column 620, the next hop type for each respective node is provided. For root node 505, there are three equal-cost paths, and so the corresponding next hop type is ECMP. Node 510 is the last hop on its particular route-path, and so its next hop type is adjacency. The next hop type for node 515 is load share, referring to the three different egress ports that are not all on the same line card. The next hop type for node 520 is recursive, referring to the single possible next hop which is not a last hop along any of its particular route-paths. Each of nodes 525, 530, and 535 is an adjacency next hop emerging from node 515. Node 540 is an ECMP node emerging from node 520, and nodes 545 and 550 are adjacencies emerging from node 540.

In the fifth column 625, the parent index is provided for each respective node. The parent index refers to the index of the node from which the corresponding next hop emerged. In the sixth column 630, the parent reference is provided for each respective node. For a particular node, the parent reference refers to the number of possible next hop blocks (i.e., “child nodes”) to which the respective node may hop on its next hop.

In the seventh column 635, the slot mask is provided for each respective node. The slot masks are computed in accordance with the fifth step of the algorithm, as described below.

In the fifth step of the algorithm, the reachable adjacency mask is calculated. Every index in the array is traversed. For every adjacency, its association with a physical port is determined, and a slot-mask is calculated. The union of slot-masks of the child nodes yields the slot-mask of any parent node in the constructed array. The slot-mask of an adjacency is applied to the parent node, and then recursively applied along the route path to the root node at index zero. When every index in the array has been traversed, the mask on the root node yields the set of slots that have at least one active physical outbound port to reach the destination. The slot-mask on the root node at index zero is termed the reachable adjacency mask.

Thus, for example, in column 635, the slot-masks are determined as follows: First, the slot-mask for each adjacency is calculated based on a determination of its association with a physical port. Nodes 510, 525, 530, 535, 545, and 550 are adjacencies. Node 510 is associated with port 1/1, and node 525 is associated with port 1/4, both of which reside on line card 1, and therefore, the slot-mask for each of nodes 510 and 525 is calculated to be 0x00000001. Node 530 is associated with port 2/1, and node 550 is associated with port 2/2, both of which reside on line card 2, and therefore, the slot mask for each of nodes 530 and 550 is calculated to be 0x00000002. Node 535 is associated with port 5/1, and node 545 is associated with port 5/2, both of which reside on line card 5, and therefore, the slot mask for each of nodes 535 and 545 is calculated to be 0x00000010. Node 540 is the parent of nodes 545 and 550, and so its slot mask is calculated as the union of the respective slot masks for nodes 545 and 550, i.e., 0x00000012. Node 520 is the parent of node 540, and so its slot mask is the union of a single slot mask, i.e., the same as the slot mask of node 540. Node 515 is the parent of nodes 525, 530, and 535, and so its slot mask is calculated as the union of the respective slot masks for nodes 525, 530, and 535, i.e., 0x00000013. Root node 505 is the parent of nodes 510, 515, and 520, and so its slot mask is calculated as the union of the respective slot masks for nodes 510, 515, and 520, i.e., 0x00000013. The slot mask of root node 505 is the reachable adjacency mask.

In the sixth step of the algorithm, the pruned next hop chain is computed. For each next hop, if the line card slot-bit falls within the slot mask, the next-hop becomes part of the tunnel FIB on that card. If the line card slot bit does not fall within the slot mask, the next hop entry is pruned from the next hop chain for that slot. There is one exception for the reachable adjacency mask (i.e., the slot mask of the route next hop node): If the slot-bit of the line card does not fall within the reachable adjacency mask, this implies that the line card has no egress links for the tunnel peer, in which case the entire next hop chain is retained.

Using the example illustrated in FIGS. 5 and 6 and applying the algorithm described above, the path information for route 2.2.2.5/32 with respect to slots 2, 5, and 9 is as follows:

Slot 2: ECMP 2.2.2.5/32, load share 20.1.1.1/32, adjacency 20.1.1.1/32, port 2/1; and recursive 40.1.1.1/32, ECMP 40.1.1.1/32, adjacency 70.1.1.1/32, port 2/2.

Slot 5: ECMP 2.2.2.5/32, load share 20.1.1.1/32, adjacency 20.1.1.1/32, port 5/1; and recursive 40.1.1.1/32, ECMP 40.1.1.1/32, adjacency 50.1.1.1/32, port 5/2.

Slot 9: No slot-specific pruning advantage. Therefore, resort to a full next-hop chain to allow any traffic on slot 9 to be equally spread across all egress interfaces. ECMP 2.2.2.5/32, adjacency 10.1.1.1./32, port 1/1; load share 20.1.1.1/32, adjacency 20.2.2.2/32, port 1/4 and adjacency 20.1.1.1/32, port 2/1 and adjacency 20.1.1.1/32, port 5/1; and recursive 40.1.1.1/32, ECMP 40.1.1.1/32, adjacency 50.1.1.1/32, port 5/2 and adjacency 70.1.1.1/32, port 2/2.

Link failures: When the egress links on a card fail, until routing converges and the tunnel FIB is updated, the full view of the complete forwarding set is necessary, so as to not overload the traffic from the failed links to the remaining active ports. During such transition periods, the traffic from the failed primary links must be equally hashed to the on-card and off-card adjacencies. A shadow pointer to the root of original next hop chain allows for faster processing of link failures.

Level compression: If a node along a path has only one child, the level can be compressed to produce smaller path lengths. This may involve transferring the properties of the parent node (if any) onto the child node. Because the tunnel FIB does not require the scalability of a regular IP FIB, such optimizations are not expensive for an independently organized data structure.

Symmetrical distribution of the access and trunk interfaces on all line cards: Instead of a conventional vertical division of the chassis into trunk and access-facing cards, a horizontal division where each card services both trunk and access interfaces may be implemented. This form of network deployment allows for increased reachability across all home slots.

Egress port bandwidth in each slot must be able to handle the bandwidth requirement of the sessions homed on that slot. Depending on the port bandwidth of a particular card, a weighted assignment of sessions to the card may be necessary in order to ensure that the ports are not oversubscribed. A static configuration-type mechanism may be used to identify the potential egress ports. In addition, sessions may be load balanced, based on bandwidth requirements. As network capacity changes (e.g., ports becoming enabled or disabled), the sessions can be rebalanced to ensure that the session bandwidth does not exceed the link capacities.

An application which does not support session load balancing can still benefit from a tunnel FIB by forwarding higher priority or premium subscriber traffic over the optimized path.

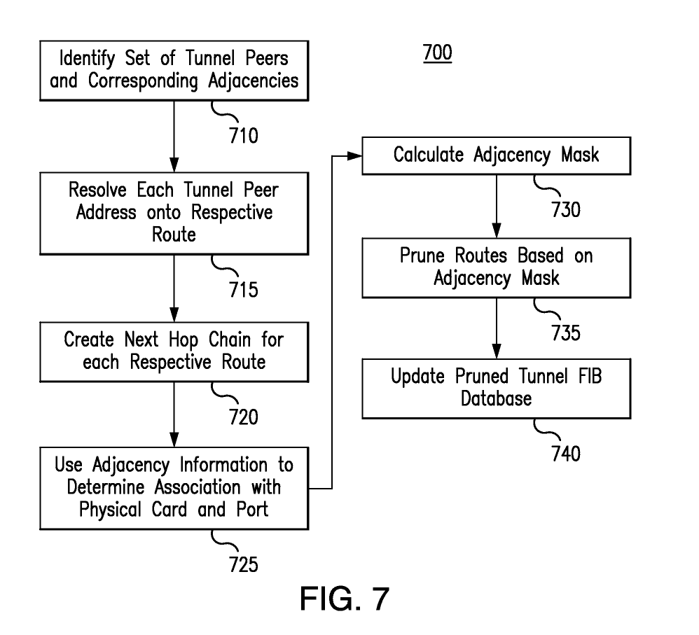

Referring now to FIG. 7, a flow chart 700 illustrating the steps in a method according to exemplary embodiments of the disclosed solution is shown. In the first step 710, a set of tunnel peers and corresponding adjacencies is identified, based on a priori signaling or static configurations.

In the second step 715, each identified tunnel peer address is resolved onto a respective route-path. Then, in step 720, a next hop chain is created for each respective route-path.

In step 725, the adjacency information is used to determine a respective association with a physical card and a physical port. Then, the adjacency mask is calculated in step 730.

In step 735, the adjacency mask is used to prune route from the set of route paths created in step 715. Finally, in step 740, the pruned tunnel FIB database is updated based on the result of pruning routes in step 735.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A method for reducing congestion and latency in a communication system configured to provide a communication link between a communication device and a network, the method comprising:
receiving a packet, the packet including identification information relating to a communication session in which the communication device is participating;
using the identification information to determine a corresponding tunnel peer address;
resolving the determined tunnel peer address onto a set of paths, each path including respective adjacency information;
determining whether to prune each respective path from the set of paths by using the respective adjacency information ;
based on the pruning determinations, reducing a number of potential paths by pruning the set of paths; and
using the pruned set of paths to identify available paths for the communication link.

2. The method of claim 1, wherein the resolving further includes creating a set of next hops corresponding to each respective path.

3. The method of claim 1, wherein the using the respective adjacency information further includes determining an association with each potential physical port corresponding to the respective path and calculating an adjacency value based on the determined association.

4. The method of claim 1, wherein the determination whether to prune the respective path is based on whether the adjacency information indicates that a next hop is on the same line card or on a different line card.

5. The method of claim 1, further comprising:
storing the unpruned set of paths in a database;
generating and updating a set of card-specific pruned sets of paths from the unpruned set of paths; and
storing each respective card-specific pruned set of paths on the respective line card.

6. The method of claim 1, wherein the network is the Internet.

7. The method of claim 1, wherein the communication device uses tunnels to participate in communication sessions.

8. A gateway node for reducing congestion and latency in a communication system, the system including a communication device and a network, the communication device in communication with the network via the gateway node, and the gateway node comprising:
a backplane;
a controller card installed in a slot and coupled to the backplane, the controller card including a processor; and
a plurality of data cards, each installed in a respective slot and coupled to the backplane such that at least one packet can be transmitted within the node from a first card to a second card via the backplane, each of the data cards including at least one port for transmitting and receiving at least one packet and a database for storing path information;
wherein, by using predetermined position information relating to a current location of the communication device and identification information relating to an active communication session in which the communication device is participating, the processor is configured to:
use the position information to determine a corresponding data card that serves the active communication session;
use the identification information to determine a corresponding tunnel peer address;
resolve the determined tunnel peer address onto a set of paths, each path including respective adjacency information;
determine whether to prune each respective path from the set of paths by using the respective adjacency information;
based on the pruning determinations, reduce a number of potential paths by pruning the set of paths; and
use the pruned set of paths to identify available paths for a communication link between the communication device and the network via the gateway node.

9. The gateway node of claim 8, wherein the processor is further configured to resolve the determined tunnel peer address by creating a set of next hops corresponding to each respective path.

10. The gateway node of claim 8, wherein the processor is further configured to use the respective adjacency information to determine an association with each potential physical port corresponding to the respective path and to calculate an adjacency value based on the determined association.

11. The gateway node of claim 8, wherein the determination whether to prune the respective path is based on whether the adjacency information indicates that a next hop is on the same data card or on a different data card.

12. The gateway node of claim 8, wherein the processor is further configured to:
store the unpruned set of paths in a database;
generate and update a set of card-specific pruned sets of paths from the unpruned set of paths; and
store each respective card-specific pruned set of paths in the database corresponding to the respective data card.

13. The gateway node of claim 8, wherein the network is the Internet.

14. The gateway node of claim 8, wherein the communication device uses tunnels to participate in communication sessions.

15. A computer program product for reducing congestion and latency in a communication system configured to provide a communication link between a communication device and a network, the computer program product comprising a non-transitory computer readable medium storing computer readable program code, the computer readable program code including instructions for causing a computer to:
use identification information relating to a communication session in which the communication device is participating and contained in the received packet to determine a corresponding tunnel peer address;
resolve the determined tunnel peer address onto a set of paths, each path including respective adjacency information;
determine whether to prune each respective path from the set of paths by using the respective adjacency information;
based on the pruning determinations, reduce a number of potential paths by pruning the set of paths; and
use the pruned set of paths to identify available paths for the communication link.

16. The computer program product of claim 15, wherein the instructions for causing a computer to resolve the determined tunnel peer address further include instructions for causing a computer to create a set of next hops corresponding to each respective path.

17. The computer program product of claim 15, wherein the instructions for causing a computer to use the respective adjacency information further include instructions for causing a computer to determine an association with each potential physical port corresponding to the respective path and to calculate an adjacency value based on the determined association.

18. The computer program product of claim 15, wherein the determination whether to prune the respective path is based on whether the adjacency information indicates that a next hop is on the same line card or on a different line card.

19. The computer program product of claim 15, wherein the computer readable program code further includes instructions for causing a computer to:
store the unpruned set of paths in a database;
generate and update a set of card-specific pruned sets of paths from the unpruned set of paths; and
store each respective card-specific pruned set of paths on the respective line card.

20. The computer program product of claim 15, wherein the network is the Internet.

21. The computer program product of claim 15, wherein the communication device uses tunnels to participate in communication sessions.
